(19) United States
(12) Patent Application Publication
(10) Pub. No.: US 2021/0186210 A1
(43) Pub. Date: Jun. 24, 2021

(54) MODULAR CASEWORK CONSTRUCTIONS USING SOLID-SURFACE MATERIALS

(71) Applicant: Gary Bohr, Plymouth, MI (US)

(72) Inventor: Gary Bohr, Plymouth, MI (US)

(21) Appl. No.: 17/127,991

(22) Filed: Dec. 18, 2020

Related U.S. Application Data
(60) Provisional application No. 62/952,390, filed on Dec. 22, 2019.

(51) Int. Cl. A47B 47/00; A47B 63/00; F16B 5/00; A47B 96/20

(52) U.S. Cl. CPC A47B 47/0075; A47B 96/206; F16B 5/0024; A47B 63/00

(57) ABSTRACT

Manufacturing and assembly techniques make the use of solid-surface materials practical for open box or case structures, bookcases, shelving units, storage units, and other caseworks, with or without back panels, doors or drawers. All of the panels involved are preferably solid-surface materials, and the panels are routed to receive hidden, push-to-connect type fasteners between the opposing side edges of the top and bottom panels and the inner surfaces of the opposing side panels. The back panel, and the top, bottom and opposing side panels may have grooves to receive the back panel. The side panels may have a height and width sufficient to cover the edges of the top, bottom and back panels when the casework is assembled. Optionally, the back panel may side edges with outwardly extending tabs, and the grooves in the opposing side panels may have recesses to receive the tabs for added strength and stability.

### REFERENCE TO RELATED APPLICATIONS

This application claims priority to, and the benefit of, U.S. Provisional Patent Application Ser. No. 62/952,390, filed Dec. 22, 2020, the entire content of which is incorporated herein by reference.

### FIELD OF THE INVENTION

This invention relates generally to casework and, in particular, to casework constructed with solid surface panels and hidden fasteners.

### BACKGROUND OF THE INVENTION

“Casework” maybe defined as box construction, which would include, without limitation, cases, cabinets, bookcases, racks, drawers, storage spaces, and the like. Various types of panels are used for casework construction, including solid wood, plywood and other laminates, and MDF (medium-density fiberboard), and the like.

Different attachment techniques are also used in casework construction. To join one panel on-edge to the surface of another panel, threaded fasteners, biscuits, mortise-and-tenon, dado/rabbets, and so forth.

‘Solid-surface’ materials are man-made composites used to produce non-porous, low-maintenance surfaces such as countertops. Natural surfaces are composed of naturally occurring materials like wood, stone, mineral, metals, clay, gum and resin. Synthetic surfaces contain, in addition to any natural materials, man-made substances such as metal alloys or polymers. Solid surfaces such as Dupont Corian® are synthetic surfaces manufactured from polymeric and engineered materials; for example, alumina trihydrate (ATH), acrylic, epoxy or polyester resins and pigments.

Since their introduction, solid-surface materials have been used in kitchen/bathroom applications for vanity countertops, bathtubs, etc., commercial counters in public places; museum displays, and for hospital and laboratory countertops.

In contrast to materials currently used for casework construction, solid-surface materials are generally homogeneous. They do not have a wood-like grain, nor are they laminated like plywood. Nevertheless, for various reasons, solid-surface materials have so far not been used for casework construction. The primary reason is that solid-surface materials are quite heavy. While this weight makes such materials ideally suited to countertop applications, conventional joinery techniques are not readily applicable to solid-surface materials due to the weight, density and other factors. Different tools are also required to “machine,” form and polish solid-surface materials.

### SUMMARY OF THE INVENTION

This invention improves upon casework construction through the use of solid-surface materials, as well as manufacturing and assembly techniques that make the use of solid-surface materials practical for casework structures. The invention may be used to assemble open box or case structures, bookcases, shelving units, storage units, and the like, with or without back panels, doors or drawers.

The invention uses a plurality of panels, each having edges and opposing flat inner and outer surfaces defining a thickness. A plurality of fasteners are used to join the edges of some panels to the inner surfaces of other panels. In the preferred embodiments, all of the panels are fabricated from solid-surface materials, and the panels are routed to receive hidden, push-to-connect type fasteners.

In accordance with one disclosed example, the plurality of panels includes a top panel, a bottom panel, opposing side panels and a back panel, and the top, bottom and opposing side panels have grooves to receive the back panel. The opposing side panels have upper and lower edges, and grooves in the opposing side panels are configured to receive the back panel do not extend all the way to the upper and lower edges of the side panels. Optionally, the back panel has side edges with outwardly extending tabs, and the grooves in the opposing side panels have recesses configured to receive the outwardly extending tabs of the back panel.

The top, bottom and back panels have side edges may define the same width, in which case the side panels may have a height and width sufficient to cover the edges of the top, bottom and back panels when the casework is assembled. Hidden, push-to-connect fasteners may be used between the opposing side edges of the top and bottom panels and the inner surfaces of the opposing side panels.

### BRIEF DESCRIPTION OF THE DRAWINGS

FIG. 1 is a perspective drawing that illustrates one casework construction using dowels according to the invention; and

FIG. 2 illustrates an alternative casework construction using elongated grooves in the solid-surface materials.

### DESCRIPTION OF THE INVENTION

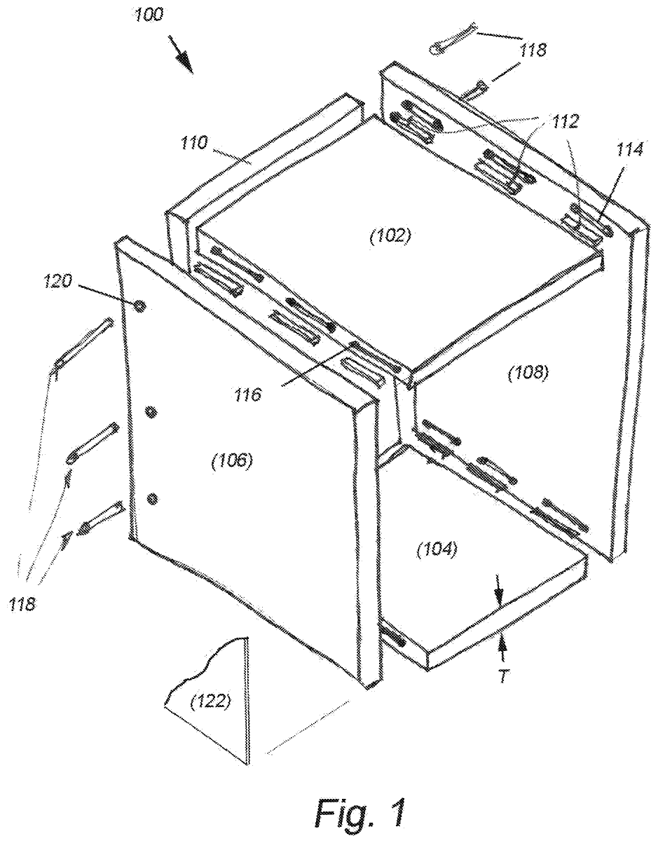

This invention improves upon the existing art of casework construction through the use of assembly components and techniques that facilitate the use of solid-surface materials. FIG. 1 is a perspective drawing that illustrates one such construction generally at 100. The preferred embodiments use solid-surface panels having a thickness “T” of 12 mm (½″ in the U.S.), which is less than half the thickness of countertops to reduce overall weight. Any suitable solid-surface material may be used, including DuPont Corian®, Phenolic Core from Wilsonart, and so forth. The invention is not limited is terms of solid-surface composition or appearance, though the 12 mm/½″ thickness is preferred.

The embodiment of FIG. 1 includes five panels, including a top 102, bottom 104, opposing sides 106, 108, and back panel 110. However, while FIG. 1 shows a simple open box configuration, the invention is not limited in terms of finished product, which may include cases and cabinets, with or without doors, with sizes dimensions other than those implied in FIG. 1. The invention is also applicable to bookcases and other configurations including shelves, as well as products with drawers. Broadly, the invention may be used to construct virtually any type of casework that uses wood, laminate or wood composite materials, but instead with solid-surface materials.

In the preferred embodiments, hidden fasteners are used to join the various solid-surface panels. For example, in FIG. 1, push-to-connect fasteners 112 may be used to join the edges of the top and bottom panels 102, 104 to the upper and lower edges of the side panels 106, 108. Such fasteners may include the invisible connection systems available from OVVO Technology of Louth, Ireland. To accommodate these connectors, slots 114, 16 are routed in the panels, enabling assembly by clicking the various edges against the surfaces to be joined.

Note that in contrast to existing wood laminate/composite construction, the invention uses relatively closely spaced hidden push-to-connect fasteners due to the density and weight of the solid-surface material. For example, the fasteners 112 may be spaced art on-center with a distance of 3 to 6 inches depending upon the size and shape of the product. Dowels 118 are also preferably closely spaced at a distance in the range of 2 to 6 inches, with or without glue.

Continuing the reference to FIG. 1, back panel 110 may be held in position with dowels 118 inserted through holes 120 along the rear edges of the side panels 106, 108. To achieve a cleaner overall appearance, a laminate 122 may be adhered to the outer surfaces of the side panels 106, 108 to cover the ends of the dowels.

Note further that while hidden, push-to-connect fasteners are preferably used to connect the sides to the top and bottom of the case and dowels are used for the back panel, fastener type is essentially interchangeable in that more or fewer of each type of connector may be used, including all push-to-connect or all dowels throughout. The same hold true of shelves, if provided, which may use push-to-connect or dowel connection techniques.

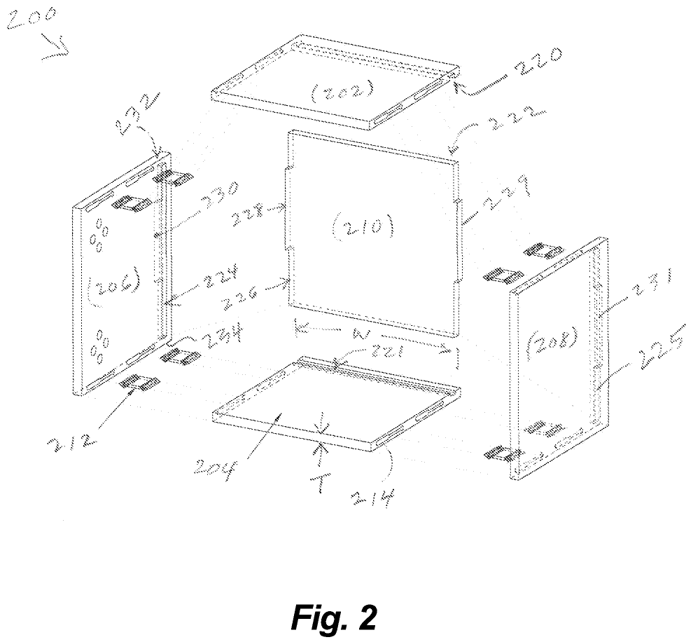

FIG. 2 is a perspective drawing that illustrates an alternative embodiment of the invention generally at 200. Again, any suitable solid-surface material may be used, including DuPont Corian®, Phenolic Core from Wilsonart, and so forth, with panels having a preferred thickness “T” of 12 mm (½″ in the U.S.). FIG. 2 also shows five panels, including a top 202, bottom 204, opposing sides 206, 208, and back panel 210. As with FIG. 1, although an open box configuration is illustrated, the invention is not limited in terms of panel sizes, overall dimensions or finished product, which again may include cases and cabinets, with or without doors, bookcases and other configurations including shelves, as well as products with drawers, and so forth.

Hidden fasteners are used to join side solid-surface panels 206, 208 to the top and bottom solid-surface panels 202, 204. Preferably, push-to-connect fasteners 212 are used to join the edges of the top and bottom panels 202, 204 to the upper and lower edges of the side panels 206, 208. Such fasteners may include the invisible connection systems available from OVVO Technology of Louth, Ireland. To accommodate these connectors, slots such as 214 are routed in the edges of the panels as shown, enabling assembly by clicking the various edges against the surfaces to be joined.

Note that in contrast to existing wood laminate/composite construction, the invention uses relatively closely spaced hidden push-to-connect fasteners due to the density and weight of the solid-surface material. For example, the fasteners 212 are preferably spaced art on-center with a distance of 3 to 6 inches depending upon the size and shape of the product.

In contrast to the construction of FIG. 1, back panel 210 is held in position with a series of grooves in the top, bottom and side panels to receive the edge of the back panel 210. In particular, the side panels have grooves 224, 225, and the top and bottom panel includes grooves 220, 221, respectively. The width of the grooves is slightly wider than the thickness of the panels used. So, for example, if 12 mm panels are used the grooves are slightly greater than 12 mm.

In the construction shown, the width W of the back panel 210 corresponds to the width of the top and bottom panels, whereas the side panels 206, 208 are longer than the height of the back panel to cover the side edges of the top and bottom panels when completed. As such, the grooves 224, 225 in the side panels do not extend all the way to the top and bottom edges to keep the grooves hidden after assembly, whereas grooves 220, 221 may extend to both opposing edges are these grooves will be hidden. Further, for added stability, the side panels may have extending tabs 228, 229 that fit into deeper recesses 230, 231 in the grooves 224, 225.

Thus, to assemble the case of FIG. 2, the grooves of the top and bottom panels are first fitted onto upper and lower edges of the back panel, then either or both of the side panels are installed using the hidden, push-to-connect fasteners. In all embodiments, more or fewer connectors may be used than those depicted in the figures, and a combination of push-to-connect and dowels, or all dowels, may instead be used. The same hold true of shelves, if provided, which may use push-to-connect or dowel connection techniques, with or without grooves.

1. A casework construction, comprising:
a plurality of panels, each having edges and opposing flat inner and outer surfaces defining a thickness;
a plurality of fasteners used to join the edges of some panels to the inner surfaces of other panels; and
wherein the panels are made from solid-surface materials.

2. The casework of claim 1, wherein the thickness is on the order of 12 mm or ½″

3. The casework of claim 1, wherein the panels are used to construct at least the following:
open box or case structures, with or without back panels;
bookcases or shelving units, with or without back panels;
cabinets, with or without doors; and
storage units, with or without drawers.

4. The casework of claim 1, wherein fasteners are hidden, push-to-connect fasteners.

5. The casework of claim 1, wherein the fasteners are dowels.

6. The casework of claim 5, further including a laminate to cover exposed dowel ends.

7. The casework of claim 1, wherein:
the plurality of panels includes a top panel, a bottom panel, opposing side panels and a back panel; and
the top, bottom and opposing side panels have grooves to receive the back panel.

8. The casework of claim 7, wherein:
the opposing side panels have upper and lower edges; and
the grooves in the opposing side panels configured to receive the back panel do not extend all the way to the upper and lower edges of the side panels.

9. The casework of claim 7, wherein:
the back panel has side edges with outwardly extending tabs; and
the grooves in the opposing side panels have recesses configured to receive the outwardly extending tabs of the back panel.

10. The casework of claim 7, wherein:
the top, bottom and back panels have side edges defining the same width; and
the side panels have a height and width sufficient to cover the edges of the top, bottom and back panels when the casework is assembled.

11. The casework of claim 7, wherein;
the top and bottom panels have opposing side edges;
the opposing side panels have inner surfaces; and
hidden, push-to-connect fasteners are used between the opposing side edges of the top and bottom panels and the inner surfaces of the opposing side panels.
